(19) United States
(12) Patent Application Publication
(10) Pub. No.: US 2023/0417000 A1
(43) Pub. Date: Dec. 28, 2023

(54) STANCHION WITH ILLUMINATED OR LIGHTED BANNER

(71) Applicant: Hidden Treasures by KDW, Inc., Alamo, CA (US)

(72) Inventor: Steven Lewis Weiner, Alamo, CA (US)

(21) Appl. No.: 18/036,247

(22) PCT Filed: Nov. 16, 2021
(86) PCT No.: PCT/US2021/059442

§ 371 Date: May 10, 2023

Related U.S. Application Data
(60) Provisional application No. 63/115,524, filed on Nov. 18, 2020.

(51) Int. Cl. E01F 13/02; G09F 13/22; E01F 9/615; E01F 9/688

(52) U.S. Cl. CPC E01F 13/028; G09F 13/22; E01F 9/617; E01F 9/688

(57) ABSTRACT

A safety stanchion includes a base. A post extends from the base. A belt reel has an interior for holding the belt. A belt is retractably mounted within the interior. The belt has an electroluminescent (EL) material operatively connected to a powersource. The electroluminescent (EL) material is visible to the general public, when extended form within the interior.

### CROSS REFERENCE TO RELATED APPLICATION

This application claims the benefit of U.S. Provisional Application No. 63/115,524 filed on Nov. 18, 2020, the entire disclosure of which is hereby incorporated in its entirety.

### TECHNICAL FIELD

This application generally relates to guide and safety stanchions, e.g., those used at airports, stadiums, theatres and other venues. More specifically, this application relates tostanchions with an illuminated reel, belt or banner.

### BACKGROUND OF THE INVENTION

Crowd control stanchions, or stanchions, provide effective directional guidance for people when dealing with lines and queues. A stanchion post, connected to a series of other stanchion posts, are highly effective crowd control barriers that maintain organization and efficient traffic flow.

Further, stanchions may be used to promote safety. For example, stanchions can be useful tools for workplace safety plans and, when used properly and with the guidance of an OSHA professional, an integral part of OSHA compliance. The stanchions and barrier system should be visible.

Accordingly, there is always a need for an improved stanchion.

### SUMMARY OF THE INVENTION

A safety stanchion includes a base. A post extends form the base. A belt reel has an interior for holding the belt. A belt is retractably mounted within the interior. The belt has an electroluminescent (EL) material operatively connected to a power source. The electroluminescent (EL) material is visible to the general public, when extended form within the interior.

In another embodiment of the invention, indicia is disposed on the belt. The indicia is formed from the electroluminescent (EL) material

In yet another embodiment of the invention, a light is removably mounted on the belt reel.

### BRIEF DESCRIPTION OF THE SEVERAL VIEWS OF THE DRAWINGS

The accompanying drawings, which are incorporated into and form a part of the specification, illustrate one or more embodiments of the present invention and, together with the description, explain the principles of the invention. The drawings are only for the purpose of illustrating one or more embodiments of the invention and are not to be construed as limiting the invention. In the drawings:

FIG. 1 is a side elevational view of a safety stanchion constructed in accordance with a first embodiment of the invention;

FIG. 2 is an exploded top perspective view of the safety stanchion constructed in accordance with a first embodiment of the invention;

FIG. 3 is a side elevational view of a safety stanchion constructed in accordance with a second embodiment of the invention;

### DETAILED DESCRIPTION

Examples of the present disclosure will now be described more fully hereinafter with reference to the accompanying drawings, in which some, but not all examples of the disclosure are shown. Indeed, various exemplary aspects of the disclosure may be embodied in many different forms and should not be construed as limited to the examples set forth herein. Rather, these examples are provided so that this disclosure will be thorough and complete and will fully convey the scope of the disclosure to those skilled in the art. Like reference numerals refer to like elements throughout.

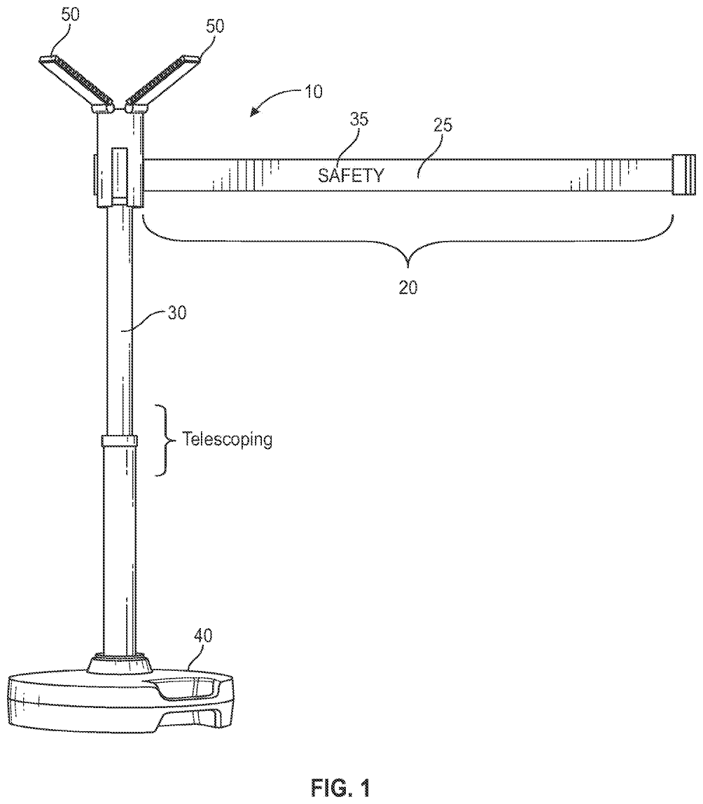

Referring to FIGS. 1 to 3, stanchion 10 includes a post 30 operatively connected to a lighted or illuminated reel, belt or banner 20. Each stanchion 10 can be post 30 mounted at its bottom end in a base 40. The base 40 can be mounted on a service or can be weighted so to prevent the post 30 from tipping. Stanchion 10 is shown with a belt 20 drawn outwardly from stanchion 10 and in which a plurality of belts drawn from other stanchions (not shown) have their respective ends secured to post 30. Stanchion 10 can have a quantity of belt 25 drawn outwardly from belt reel 20 in a direction. In the anticipated use of stanchion 10, belt 25 is drawn outwardly from belt reel 20 a sufficient distance to secure the belt 20 on another stanchion or another structure (not shown) by a clasp 27 affixed to a free end of belt 20.

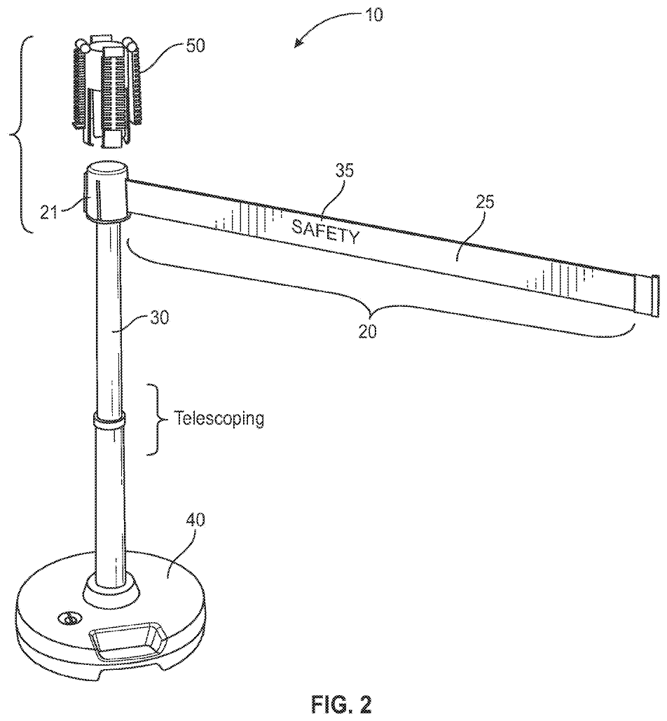

Referring now to FIG. 2, stanchion 10 includes a support base 40 together with a generally vertically extending post 30. Post 30 can be a typical post and the reel or belt 20 is operatively connected to the post 30. Reel belt 20 supports a message 35 thereon and belt reel 21 can have lights 50 removably disposed thereon.

the reel belt 20 supports a visible message or indicia 35, which can be connected to a power source so to allow the lights on the belt 20 to glow. The belt reel 21 can have a quantity of belt 20 wound therein. Belt 20 defines an outer end having clasp 27 capable of being secured to a belt connection 22 or belt reel, which can include a power source for powering the lights on the belt. Belt real 20 can be on a typical spool, which are known in the industry. The base 40 is shown as circular, but may be oval, rectangular or any other shape.

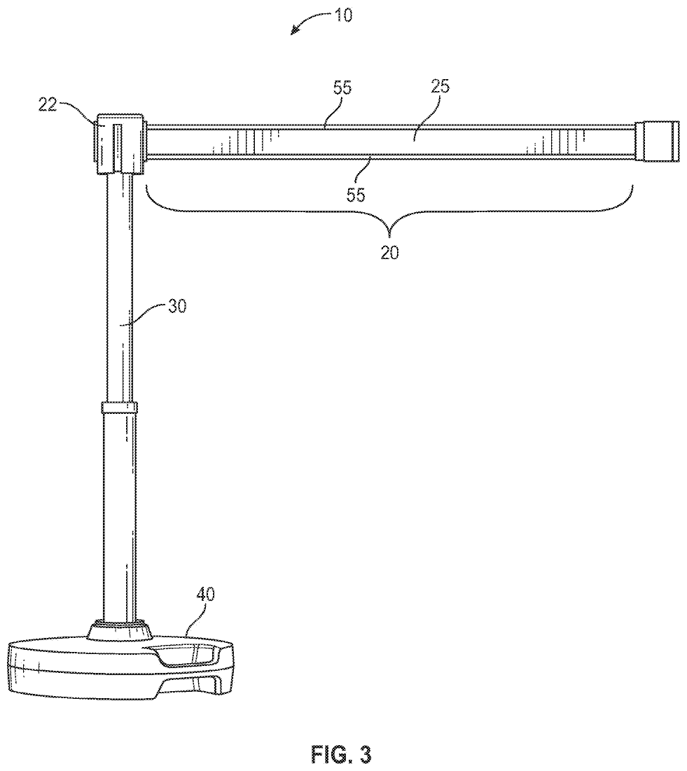

In one embodiment, the light on the belt can be an LED light of panels the is operatively connected to a power source. For example and as shown in FIG. 3, there can be electroluminescent strips 55 on each side of the belt extending from a reel connection 22, and in this example the strips 55 are disposed along or on top and bottom of the belt 20.

Technology suitable (e.g., flat electroluminescent material) to apply to the belt 40 is known in the art and available through Banner Stakes and are shown in U.S. Pat. No. 9,175,450.

In one embodiment, the power source for powering the lighting strips 55 can be a hard wire or batteries or the like. Examples of suitable power sources include, but are not limited to, disposable batteries, rechargeable batteries, etc. In one embodiment, the electrical arrangement includes control electronics such as an electrical inverter, or other electronics.

In one embodiment, power source (not shown) and control electronics are located separately at the reel belt or connection 22. In one embodiment, the electrical arrangement includes an electrically connection to allow the strips 55 through a detachable connector so to allow removal of the reel belt from the stanchion 10. Alternatively, the power source may be solar panel.

The banner or belt 20 can be indicia and can “glow” so to improve safety, or portions thereof such as indicia 35 can glow with belt 20 as backdrop. The glow provided by this embodiment enhances the visibility of the stanchion and belt to allow improved safety and guidance.

In one embodiment, the post can be a telescoping post or column, e.g., shown in the figures. In this arrangement, the telescoping mechanism may be a simple or as complex as is known in the art. Telescoping in mechanics describes the movement of one part sliding out from another, lengthening an object (such as a telescope or the lift arm of an aerial work platform) from its rest state.

In another embodiment, the post can be illuminated as well. In this arrangement, one or more lights (e.g., LEDs) may be in or along the post 30. The mechanism may be similar to that presented herein for the belt illumination, except the illumination is along the post 30.

In another embodiment, there can be one or more lights 50 on the belt reel 22. In this arrangement, a folding type light arrangement 50 arranged with the belt reel connection 22. The light 50 can be any type of light suitable for connection to post 30 or at belt reel connection 22.

In another embodiment, there can be one or more lights that illuminates downward. In this case, the light can glow on the ground.

It will be appreciated that the apparatus and features described herein may be made of materials metallic, polymeric, plastic, inorganic, synthetic, and natural. These materials include, but is not limited to, metals and alloys, such as steel, stainless steel, galvanized metals, copper, copper alloys, nickel, nickel alloys, iron, iron alloys, aluminum, titanium, and other alloys thereof, combinations thereof, and/or other equivalent material intended for a post. In certain embodiments, the stanchion may also include materials plastic, including, but not limited to, PVC and HDPE.

Although specific embodiments have been illustrated and described herein, it will be appreciated by those of ordinary skill in the art that any arrangement which is calculated to achieve the same purpose may be substituted for the specific embodiment shown. This application is intended to cover any adaptations or variations of the present invention. It is to be understood that the above description is intended to be illustrative, and not restrictive.

Combinations of the above embodiments, and other embodiments will be apparent to those of skill in the art upon reviewing the above description. The scope of the invention includes any other applications in which the above structures and fabrication methods are used. The scope of the invention should be determined with reference to the appended claims, along with the full scope of equivalents to which such claims are entitled.

1. A safety stanchion, comprising:
a base;
a post extending from said base;
a belt reel, mounted on the post, the belt reel having an interior; and
a belt, retractably stored in said interior, and having electroluminescent material thereon, operatively connected to a powersource.

2. The stanchion of claim 1, further comprising indicia disposed on the belt.

3. The stanchion of claim 2, wherein the electroluminescent material forms at least a portion of the indicia.

4. The stanchion of claim 1, further comprising a light removably mounted on the reel.

5. The stanchion of claim 1, wherein the post is a telescoping post.
